(19) United States
(12) Patent Application Publication
(10) Pub. No.: US 2011/0037971 A1
(43) Pub. Date: Feb. 17, 2011

(54) SMOKE DETECTION BY WAY OF TWO SPECTRALLY DIFFERENT SCATTERED LIGHT MEASUREMENTS

(75) Inventors: Markus Loepfe, Feldmeilen (CH); Kurt Mueller, Maennedorf (CH); Georges A. Tenchio, Ebmatingen (CH); Walter Vollenweider, Steinhausen (CH)

Correspondence Address: LERNER GREENBERG STEMER LLP, P O BOX 2480, HOLLYWOOD, FL, 33022-2480, US

(73) Assignee: Siemens Aktiengesellschaft, Muenchen (DE)

(21) Appl. No.: 12/735,846

(22) PCT Filed: Feb. 16, 2009
(86) PCT No.: PCT/EP2009/051756

§ 371 Date: Nov. 3, 2010

(30) Foreign Application Priority Data
Feb. 19, 2008 (EP) 08101742.8

(51) Int. Cl. G01N 21/53

(52) U.S. Cl. 356/51; 356/341

(57) ABSTRACT

A device for detecting smoke based on the principle of optical scattered light measurements has a light emitting device, configured to issue a temporal succession of light pulses. A first light pulse has a first spectral distribution and a second light pulse has a second spectral distribution that is different from the first spectral distribution. A light receiver receives a first scattered light from the first light pulse and a second scattered light from the second light pulse, and generates a first output signal that is indicative for the first scattered light, and a second output signals that is indicative for the second scattered light. An evaluation unit compares the first output signal with the second output signal. In a preferred embodiment of the device, the light emitter and the light receiver are arranged directly next to one another.

The present invention relates to the technical field of hazard warning systems. The present invention relates in particular to a device for detecting smoke on the basis of optical scattered light measurements. The present invention further relates to a method for detecting smoke based on the principle of optical scattered light measurements.

Optical or photoelectric smoke detectors generally operate according to the scattered light method. In this case use is made of the knowledge that clear air reflects practically no light. If, on the other hand, the air contains smoke particles, illuminating light transmitted by a light source is at least partially scattered by the smoke particles. Some of said scattered light then falls onto a light receiver which is not directly illuminated by the light beam. Without smoke particles in the air the illuminating light cannot reach the light-sensitive sensor.

A fire detector which has a laser light source is known from EP 0 472 039 A2. The laser light source is configured for emitting short laser pulses into a surveillance zone. The fire detector also has a light detector which is arranged near to the laser light source and which is configured for detecting laser light scattered back through 180° from smoke or other objects contained within the surveillance zone. The position of a back-scattering object within the surveillance zone can be determined on the basis of the time difference between transmitted and received laser pulses. The type of smoke detected can also be ascertained by means of a suitable comparison with time differences acquired by means of reference measurements. In particular it is possible to differentiate between black smoke and white smoke. However, the fire detector described in EP 0 472 039 A2 has the drawback that the overhead involved in measuring and analyzing the time difference is relatively high.

EP 1 039 426 A2 discloses a smoke detector which has a housing and, arranged inside the housing, a light transmitter and a light receiver. A smoke detection zone defined by means of the spatial arrangement of light transmitter and light receiver is located outside of the smoke detector. However, the smoke detector described in EP 1 039 426 A2 has the drawback that insects infiltrating the smoke detection zone can falsify the detection of smoke.

DE 10 2004 001 699 A1 discloses a fire detector which is based on the well-known scattered radiation principle. The fire detector has a plurality of radiation transmitters and a plurality of radiation receivers whose radiation paths define a plurality of spaced-apart scattering volumes or detection zones. The detection zones are locally spaced apart from one another such that small measurement objects such as insects, for example, cannot move simultaneously through multiple detection zones. In this way it is possible to differentiate between light scattered by a small measurement object and a fire incident in which smoke is spread across all the detection zones. However, the fire detector has the drawback that it has a plurality of mutually independent light paths, each having both a light transmitter and a light receiver. The overhead in terms of hardware required for the fire detector is consequently comparatively high.

The object underlying the invention in relation to the device is to create a simply constructed, open scattered light smoke detector which is characterized on the one hand by high reliability in respect of the detection of smoke and on the other hand by low false alarm probability in the event of insects being present in the detection zone. The object underlying the invention in relation to the method is to disclose a method for detecting smoke on the basis of optical scattered light measurements which is likewise characterized on the one hand by high reliability in respect of the detection of smoke and on the other hand by low false alarm probability in the event of insects being present in the detection zone.

This object is achieved by means of the subject matter of the independent claims. Advantageous embodiment variants of the present invention are described in the dependent claims.

According to a first aspect of the invention, a device for detecting smoke on the basis of optical scattered light measurements is described. The described device has (a) a light emitting apparatus, configured for emitting a temporal sequence of light pulses, a first light pulse having a first spectral distribution and a second light pulse having a second spectral distribution which is different from the first spectral distribution, (b) a light receiver, configured for receiving first scattered light from the first light pulse and second scattered light from the second light pulse, and for providing a first output signal which is indicative of the first scattered light, and a second output signal which is indicative of the second scattered light, and (c) an analysis unit, configured for comparing the first output signal with the second output signal.

The described device for detecting smoke, also referred to for short hereinbelow as a scattered light smoke detector, is based on the knowledge that different light scatterers that may be present in the detection range of the scattered light detector can be discriminated from one another in that their optical scattering properties at different wavelengths can be compared with one another.

The light receiver is preferably arranged spatially relative to the light emitting apparatus in such a way that the primary illuminating light transmitted by the light emitting apparatus does not strike the light receiver. This applies both to the first and to the second light pulses. In the event of the absence of any light scatterers in the detection range of the scattered light smoke detector this means that no light beams whatever will reach the light receiver.

The described scattered light smoke detector can be in particular an open smoke detector. This means that a spatially separate scattering chamber, which is often referred to also as a labyrinth, is not required.

Through the analysis of the sometimes spectrally different scattering properties of possible scattering objects a distinction can reliably be made between a detection of smoke and a detection of other light scatterers that are located in the detection range of the open scattered light smoke detector. Such other light scatterers can be in particular insects which may have penetrated into the detection range of the scattered light smoke detector. Equally, light scatterers of said kind can also be typically stationary object such as for example floor, wall or side surfaces of a space monitored by means of the described scattered light smoke detector.

In the described scattered light smoke detector the two output signals are in each case indicative of the respective scattered light. The output signals can in this case preferably be directly proportional to the respective scattered light intensity. This means that the light receiver and the analysis unit connected downstream of the light receiver operate in a linear manner. A doubling of the scattered light intensity will then lead to an increase in the respective output signal by a factor of two.

According to an exemplary embodiment of the invention the analysis unit is configured for calculating a difference between the first output signal and the second output signal. This has the advantage that smoke can be differentiated in a particularly easy manner from other scattering objects. The reason for this is that with most objects the scattering behavior is at least in a first approximation independent of the wavelength of the light.

It is pointed out that in the case of a solid object as measurement object the analysis of the signal as a function of the difference between the two output signals is advantageous in particular when said object is located relatively far away from the light emitting apparatus and/or the light receiver. In the case of a solid object that is located in the vicinity of the scattered light smoke detector the signal amplitudes can both be very great. However, whether they are actually exactly equal in size, such that a zero signal results from the difference calculation between two relatively large signals, is rather unlikely in practice. It is therefore altogether possible that when a difference is calculated between two very large signals a difference signal remains which in terms of its signal strength at least corresponds to the order of magnitude of a smoke difference signal.

The described difference calculation is suitable in particular for a highly accurate scattered light measurement from smoke or from a measurement object that is at a relatively long distance from the scattered light smoke detector when the two light paths of the first light pulse and second light pulse are aligned with regard to the resulting output signals. In an alignment the intensity of the two light pulses can be set for example such that when the light of the two light pulses is scattered from a reference scattering object the two output signals are equally strong. For example, the reference object can be a simple black scattering object which is introduced into the measurement range of the scattered light smoke detector during the alignment.

In contrast to the reference scattering object or to an insect that has infiltrated into the measurement range, a substantially greater difference signal is produced when smoke is the scattering medium than in the case of a measurement object which is located relatively far away from the light emitting apparatus and/or the light receiver. The reason for this is that light scattering from smoke exhibits a strong wavelength dependence. The dependence of the intensity I of light scattered from smoke aerosols on the wavelength λ is described at least approximately by the following relation (1):

I(λ)˜(1/λ)ⁿ (1)

In this case n typically lies in the range between 4 and 6.

Thus, should a strong but only weakly time-variable difference signal result following a correct alignment of the two light pulses during the operation of the scattered light smoke detector, then this is a reliable indication of the presence of smoke.

It is pointed out that insects located in the measurement range can also lead to large single signals whose ratio is close to one. In addition, however, said ratio typically exhibits strong time-variable or abrupt fluctuations which are caused by a typical movement of the respective insect. Two strongly time-variable difference signals having large and roughly equal amplitude are accordingly a reliable indication of the presence of insects.

According to an exemplary embodiment of the invention the analysis unit is configured for determining the ratio of the amplitude of the first output signal to the amplitude of the second output signal. The described amplitude ratio can also be determined based on the two previously determined amplitudes of the first output signal and the second output signal.

The analysis of the amplitude ratio has the advantage that there will always be a signal ratio approximately equal to one in the case of solid objects having a weak wavelength dependence of the scatter signal irrespective of the distance of the object from the scattered light detector. In this case the signal ratio for a solid object is significantly different from the signal ratio of smoke irrespective of the object's distance from the scattered light smoke detector. The above-cited relation (1), namely, yields the following relation (2) for the ratio of the amplitudes or, as the case may be, the intensities of two scattered light signals:

I(λ1)/I(λ2)·(λ2/λ1)ⁿ (2)

Here too, n typically lies in the range between 4 and 6.

Assuming λ2=2·λ1, a value of approximately 16 to 64 is yielded from the relation (2) for the ratio I(λ1)/I(λ2).

In this point the described analysis of the amplitude ratio differs from the above-described difference calculation. In the above-described difference calculation, namely, a value I(λ1)−I(λ2) would result for the case λ2=2·λ1, which, considering the relation (1), is approximately equal to I(λ1). Thus, valuable information would possibly be lost. The analysis of the amplitude ratio described here should therefore be preferred over the above-described difference calculation for the majority of applications.

According to a further exemplary embodiment of the invention the light emitting apparatus and the light receiver are arranged immediately adjacent to each other. This has the advantage that the entire scattered light smoke detector can be implemented within a particularly compact design. In particular when optoelectronic components are used for the light emitting apparatus and the light receiver, the scattered light smoke detector can be realized for example with a maximum linear extension of approximately 7 mm.

All the electronic and/or optoelectronic components can be mounted on a common printed circuit board. This means that in addition the described scattered light smoke detector can be realized within a low height extension. Accordingly, the scattered light smoke detector can be an inconspicuous object which is suitable for many applications. At the same time both installation space-related and esthetic specifications can be fulfilled in a simple manner.

According to a further exemplary embodiment of the invention the light emitting apparatus has a first light source and a second light source.

The two light sources can be, for example, two light-emitting diodes which preferably are arranged immediately next to each other. The two light sources can furthermore be implemented using what is termed a multichip LED which has at least two elements emitting light in different spectral ranges. In this case the two light-emitting elements are arranged in close spatial proximity to each other anyway.

As small a distance as possible between the two light sources has the advantage that the spatial signal paths for the two light pulses are approximately equal. Thus, in particular when two light pulses occur in quick succession in time, the scattering from an insect still leads to two signals having at least approximately equal amplitude, which yield an amplitude ratio of at least approximately one in a separate signal acquisition and subsequent amplitude comparison. This applies at any rate as long as the time difference between the two light pulses is significantly less than the typical timescale of movements of insects.

It is pointed out that the light emitting apparatus can also be realized by means of a light-emitting element from which both light pulses emerge. The light-emitting element can be, for example, the end of an optical waveguide whose other end is split into two part-ends. One part-end can then be optically coupled to a first pulsed light source and the other part-end can be coupled to the second pulsed light source.

According to a further exemplary embodiment of the invention the device additionally has a microcontroller which is coupled at least to the light emitting apparatus and to the analysis unit and which is configured for time-synchronizing at least the light emitting apparatus and the analysis unit.

By means of the described synchronization of the operation of the light emitting apparatus and the analysis unit it can be ensured that the two output signals are also actually assigned to the respective light pulse.

It is pointed out that the microcontroller and the analysis unit can also be implemented within an integrated component. In this case the analysis unit can be implemented by means of software or by means of one or more special electrical circuits, i.e. in hardware, or in an arbitrary hybrid form, i.e. by means of software components and hardware components.

According to a further exemplary embodiment of the invention the first light pulse lies in the near-infrared spectral range and/or the second light pulse lies in the visible spectral range, in particular in the blue or violet spectral range. This has the advantage that both light pulses can be realized by means of simple optoelectronic components. In particular a light-emitting diode emitting in the near-infrared spectral range can provide the corresponding light pulses with a high intensity. This applies all the more so since the two optoelectronic components can each have applied to them a current intensity which is higher than the current intensity that in the case of a stationary current feed would lead to thermal destruction of the respective light-emitting diode. This is because the respective light-emitting diode can cool down at least to some degree between two succeeding light pulses of the same type.

In this case the first light pulse can have, for example, a wavelength of 880 nm (near-infrared spectral range). The second light pulse can have, for example, a wavelength of 420 nm (blue range of the visible spectrum).

According to another exemplary embodiment of the invention the first and/or second light pulse have/has a temporal length in the range between 1 μs and 200 μs, in the range between 10 μs and 150 μs, or in the range between 50 μs and 120 μs. A pulse length of 100 μs for both light pulses appears particularly preferable at the present time.

The repetition rate can be yielded in this case from the sum of the temporal lengths of the individual light pulses. Equally, a rest interval can follow a predefined pulse sequence comprising at least one first light pulse and one second light pulse, so that the effective repetition rate is considerably less than the inverted sum of the individual pulse durations. A rest interval of said kind can serve, for example, to reduce the effective power requirement of the described scattered light smoke detector. This is advantageous in particular in the case of a battery- or accumulator-powered device since by this means the life of the battery or accumulator can be considerably lengthened.

It is pointed out that the present invention is by no means limited to the use of two types of light pulses. Rather, three or even more than three spectrally different light pulses of a predefined sequence can also be analyzed in a suitable manner. This can produce an additional improvement in the accuracy of the spectral discrimination of different scattering objects.

It is furthermore pointed out that the number of first light pulses and the number of second light pulses within a basic cycle does not necessarily have to be the same. Thus, for example, it is conceivable that the first light pulse is significantly more intense than the second light pulse. The above-described alignment can also be achieved in that the ratio between the number of first light pulses and the number of second light pulses is not equal to one and in that the respective output signals of the two light pulses are integrated within a basic cycle. By suitable selection of this ratio an alignment can then be carried out between the corresponding integrated output signals of the different light pulses.

According to another exemplary embodiment of the invention the device additionally has an insect-repelling device which is coupled to the analysis unit and which can be activated in the event of strong time-variable fluctuations in the first output signal and/or in the second output signal. The insect-repelling device can be, for example, a small “ultrasonic mosquito repeller” which repels the insects by emitting an ultrasound tone that is very unpleasant to insects currently crawling over the light emitting apparatus, for example, and/or over the light receiver and as a result cause strong variations in the first output signal and/or in the second output signal.

According to another aspect of the invention a method for detecting smoke on the basis of optical scattered light measurements is disclosed. The method can have in particular a device of the above-mentioned type. The disclosed method comprises (a) transmitting a temporal sequence of light pulses by means of a light emitting apparatus, wherein a first light pulse has a first spectral distribution and a second light pulse has a second spectral distribution which is different from the first spectral distribution, (b) receiving first scattered light from the first light pulse and second scattered light from the second light pulse by means of a light receiver, (c) providing a first output signal that is indicative of the first scattered light and a second output signal that is indicative of the second scattered light, and (d) comparing the first output signal with the second output signal by means of an analysis unit.

The disclosed method for detecting smoke is also based on the knowledge that different light scatterers that may be located in the detection range of the scattered light detector can be discriminated from one another through comparison of their optical scattering properties at different wavelengths with one another.

According to an exemplary embodiment of the invention the method additionally comprises an aligning of the intensities of the two light pulses such that when the two light pulses scatter off a reference scattering object the first output signal and the second output signal are equal in size.

For example, the reference object can be a simple black scattering object that is introduced into the measurement range of the scattered light smoke detector during the alignment.

According to a further exemplary embodiment of the invention the above-described comparison of the first output signal with the second output signal includes the calculation of a difference between the first output signal and the second output signal.

As a result of the described calculation of a difference between the two output signals a difference signal can be generated which is indicative to a special degree of the presence of smoke in the detection range of the scattered light smoke detector. This is owing to the fact that, in contrast to stationary objects such as the walls or floor of a monitored space, for example, or moving objects such as insects, for example, the scattered light behavior of smoke is strongly dependent on wavelength. This is because when smoke is present a particularly strong change in the difference signal will be established. This applies in particular to the case where the two light paths of the first light pulse and the second light pulse are aligned in terms of the resulting output signals so that in the normal case a difference signal of at least approximately zero will result.

At this juncture it is pointed out that the presence of insects can also lead to a relatively large difference signal. However, this typically exhibits relatively abrupt fluctuations which are caused by a typical movement of the respective insect. Accordingly, a strongly time-variable difference signal is a reliable indication of the presence of insects. In contrast thereto, a great similarity or a correlation, in particular in respect of time, is a further indication on the basis of which a smoke-based scatter signal can be discriminated from a scatter signal caused by insects.

According to another exemplary embodiment of the invention the method additionally comprises compensating a slowly varying difference signal toward a zero signal. In this way a difference signal which is based on a slowly varying first output signal and/or second output signal can be corrected such that in the absence of smoke the difference signal is at least approximately equal to zero. Starting from a zero signal, the presence of smoke can then be reliably detected by means of a difference signal which is significantly different from the typical zero signal.

Different output signals can be caused, for example, by a slightly wavelength-dependent attenuation of light pulses reflected from the floor or side walls of a space that is to be monitored. Different output signals can also be caused by a time-variable and wavelength-dependent scattering behavior of the floor or side walls. However, these effects typically occur on a very slow timescale, such that they can be reliably differentiated, for example by means of a suitable filtering of the difference signal, from a strongly varying difference signal which is generated by the presence of smoke.

Further advantages and features of the present invention will emerge from the following exemplary description of currently preferred embodiments.

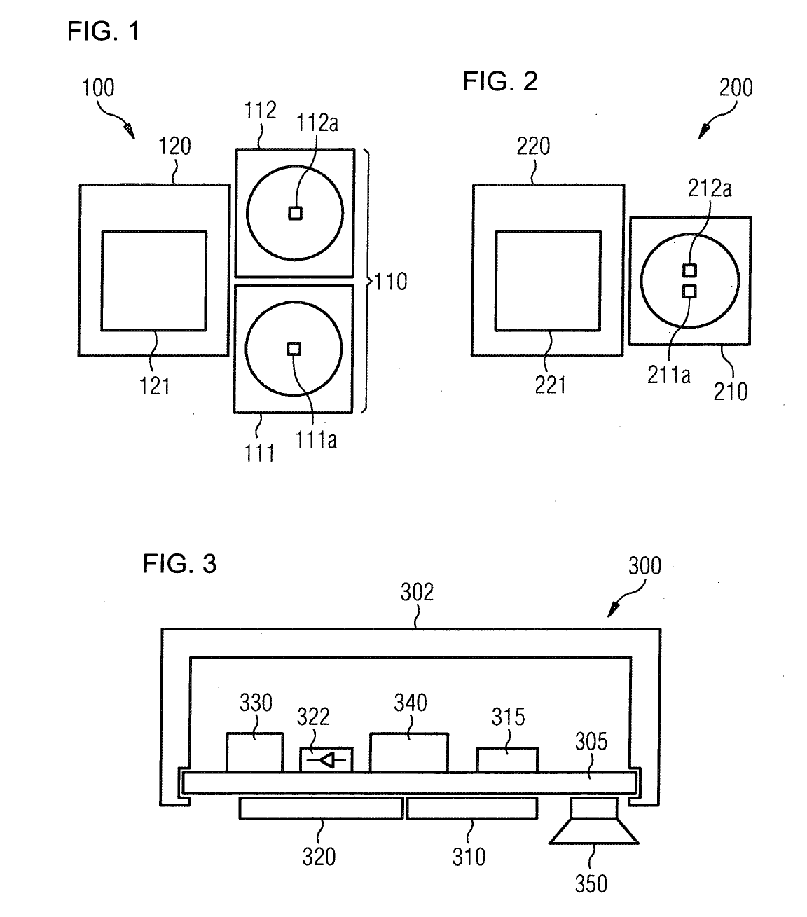

FIG. 1 shows a plan view of a scattered light smoke detector comprising a photodiode and two light-emitting diodes immediately adjacent to the photodiode.

FIG. 2 shows a plan view of a scattered light smoke detector comprising a photodiode and a two-chip light-emitting diode which is disposed immediately adjacent to the photodiode.

FIG. 3 shows a cross-sectional view of the scattered light smoke detector depicted in FIG. 1 in which all the electronic and optoelectronic components are mounted on a common printed circuit board.

At this point it remains to be noted that in the drawing the reference numerals of like or mutually corresponding components differ only in their first digit.

FIG. 1 shows a plan view of a scattered light smoke detector 100. The scattered light smoke detector 100 has a printed circuit board (not shown in FIG. 1) on which all of the electronic and optoelectronic components of the scattered light smoke detector 100 are mounted.

The scattered light smoke detector 100 has a light emitting apparatus 110 which comprises two light sources, a first light-emitting diode 111 and a second light-emitting diode 112. The first light-emitting diode 111 has a light-emitting chip 111a. According to the exemplary embodiment shown here, the chip 111a emits infrared light with a wavelength of 880 nm. The second light-emitting diode 112 has a light-emitting chip 112a. According to the exemplary embodiment shown here, the chip 112a emits a blue light with a wavelength of 420 nm.

The two light-emitting diodes 111 and 112 are operated in a pulsed mode, each light-emitting diode 111, 112 emitting light pulses with a temporal length of 100 μs for example. The pulsed operation of the two light-emitting diodes 111 and 112 is synchronized one with the other in such a way that the two light pulses are fired or, as the case may be, activated with a very small time lag. According to the exemplary embodiment shown here, said time lag between an infrared light pulse and a blue light pulse amounts to approx. 1 to 100 μs.

The described scattered light smoke detector 100 is an open smoke detector. Consequently the smoke detector 100 has no scattering chamber separated from the environment. Rather, the smoke is detected from smoke particles that are located above the drawing plane in FIG. 1. At least some of the illuminating light pulsed by the two light-emitting diodes 111, 112 is in this case scattered off the aerosols of the smoke and in turn some of the scattered illuminating light strikes the active surface 121 of a photodiode 120.

As can be seen from FIG. 1, the two light-emitting diodes 111 and 112 are arranged immediately adjacent to the photodiode 120. This means that the housings of these components immediately adjoin one another or are aligned flush with one another. According to the exemplary embodiment shown here, the entire arrangement has a maximum linear extension of 7 mm.

As a result of the immediately succeeding activation of the two light-emitting diodes the photodiode 120 now sequentially measures a first optical scattered light signal in the near-infrared spectral range and a second optical scattered light signal in the blue spectral range. By comparing the scattered light intensities of said two scattered light signals it is therefore possible to obtain valuable information about the nature of the scattering object or of the scattering medium.

In order to suppress the effects of insects that are present in the scatter volume during the analysis of the two scattered light intensities use can be made of the fact that insects are not colored, but are black, gray or brown. Accordingly their spectral reflection has a very flat curve. This means that they reflect or, as the case may be, scatter similarly strongly in the infrared and in the blue wavelength range.

A method is described below by means of which, while using the scattered light smoke detector 100, different scattered light signals can be differentiated from one another based on their spectral signature and/or their variations with time.

First, the photocurrents of the two light sources 111 or 111a and 112 or 112a are matched in an alignment method such that the difference between the two measurement signals that are generated with a time offset by the photodiode and are caused by radiation reflected from a black background is equal to zero.

During the operation of an open optical scattered light detector 100 there are then signals from four different causes that must be reliably differentiated from one another in order to provide useful smoke detection. This is possible with the described scattered light smoke detector 100.

a) Signals from the floor or a side wall of a space that is to be monitored are possibly not exactly equal in strength due to the different wavelength of the two light-emitting diodes 111 and 112. However, they will in any case be at least similarly strong in terms of their amplitude. If a difference calculation yields a value different from zero, a small offset signal is produced. This has to do neither with the detection of smoke nor with the effect of insects. For reliable operation with high sensitivity said offset signal should be corrected such that it always assumes the signal level zero.

b) Scattered light measurement signals from flying insects result in the same signal if the alignment procedure is performed successfully for both light-emitting diodes 111, 112. This is attributable in particular to the three following factors:

b1) The spectrally flat curve of the scattering behavior of the insects already described above.

b2) Owing to the miniaturized structure of the scattered light smoke detector 100 the relative spatial positions of the photodiode 120, an insect and the two light-emitting diodes 111, 112 are virtually identical for both types of light pulses.

b3) The two light-emitting diodes 111, 112 are activated approximately simultaneously. This means that a movement of the insect within a time interval between the two succeeding light pulses can be ignored in a good approximation.

The two measurement signals reflected from an insect and received by the photodiode 120 are therefore virtually identical for both light-emitting diodes 111, 112. These measurement signals are omitted in the difference calculation.

c) If smoke is present, then its scattered light signal for the blue light-emitting diode 112 is greater by a multiple than for the infrared light-emitting diode 111. This is because the spectral scattering behavior of smoke aerosols is very steep. The light reflected from the smoke aerosols is dependent with approximately (1/λ) to the power of n on the wavelength λ, where, dependent on the type and density of the smoke, n is a number between about 4 and about 6. Thus, a large difference signal persists in the difference calculation between the two measurement signals. This is a clear indicator for the presence of smoke in the scatter volume.

d) Insects that crawl across the photodiode 120 or the light-emitting diode 111, 112 can be detected by way of very strong fluctuations in the measurement signals. In order to repel the insects in this case an insect repelling device can be used in addition if necessary. The insect repelling device can be an ultrasonic mosquito repeller, for example.

By means of the open scattered light smoke detector 100 described with this application it is therefore possible to mask out in an effective manner the scattered light signals caused by insects that are present in the detection range. Furthermore the described scattered light smoke detector 100 can be implemented in a miniaturized design.

FIG. 2 shows a plan view of a scattered light smoke detector 200. The scattered light smoke detector 200 is different from the scattered light smoke detector 100 shown in FIG. 1 only in that a so-called multichip light-emitting diode 210 is used instead of two light-emitting diodes. The multichip light-emitting diode 210 comprises a chip 211a emitting in the infrared spectral range and a chip 211b emitting in the blue spectral range. The photodiode 220 is the same as the photodiode 120 of the scattered light smoke detector 100 and will therefore not be explained again. The same applies to the spatial arrangement with the components photodiode 220 and multichip light-emitting diode 210 that are immediately adjacent to each other. The distance from the center of the photodiode 220 to the center of the multichip light-emitting diode 210 amounts to less than 4 mm.

FIG. 3 shows a cross-sectional view of the scattered light smoke detector shown in FIG. 1, in this case labeled with the reference numeral 300. The scattered light smoke detector 300 has a housing 302. Provided in the lower section of the housing 302 is a groove-shaped recess which serves as a retainer for a printed circuit board 305. All the electronic and optoelectronic components of the scattered light smoke detector 300 are mounted on the printed circuit board 305. The printed circuit board thus serves not only as a carrier for conductor tracks (not shown in FIG. 3) which electrically connect the individual components of the scattered light smoke detector 300 with one another in a suitable manner. The printed circuit board 305 therefore also serves as a mechanical retainer for the components of the scattered light smoke detector 300.

Located on the underside of the printed circuit board 305 are the light emitting apparatus 310 embodied as a two-chip light-emitting diode and the photodiode 320. Also contained on the underside of the common printed circuit board 305 are an insect repelling device 350 embodied as an US mosquito repeller. This can be activated whenever it is discovered during the above-described signal analysis that an insect is located directly on the light-emitting diode 310 and/or the photodiode 320 or is flying around in the vicinity of said two optoelectronic components.

On the top side of the printed circuit board 305 is driver electronics 315 for driving the two-chip light-emitting diode 310 in a suitable manner. Also contained on the top side of the printed circuit board 305 is a photomultiplier 322 which is connected downstream of the photodiode 320, and an analysis unit 330 which is connected downstream of the photomultiplier 322. Additionally disposed on the top side of the printed circuit board 305 is a microcontroller 340 which controls the entire operation of the scattered light smoke detector 300.

The microcontroller 340 and the analysis unit 330 can also be embodied as a common integrated component.

It is pointed out that the embodiment variants described herein represent only a limited selection from possible embodiment variants of the invention. It is therefore possible to combine the features of individual embodiment variants with one another in a suitable manner such that by means of the embodiment variants explicitly described herein a multiplicity of different embodiment variants are to be considered disclosed as obvious for the person skilled in the art.

1-13. (canceled)

14. A smoke detecting device operable on a basis of optical scattered light measurements, the device comprising:
a light emitting apparatus configured to emit a temporal sequence of light pulses, the light pulses including a first light pulse having a first spectral distribution and a second light pulse having a second spectral distribution different from the first spectral distribution;
a light receiver disposed to receive a first scattered light from the first light pulse and second scattered light from the second light pulse, said light receiver being configured to generate
a first output signal indicative of the first scattered light; and
a second output signal indicative of the second scattered light; and
an analysis unit connected to said light receiver and configured to compare the first output signal with the second output signal.

15. The device according to claim 14, wherein said analysis unit is configured for calculating a difference between the first output signal and the second output signal.

16. The device according to claim 14, wherein said analysis unit is configured for determining a ratio between an amplitude of the first output signal and an amplitude of the second output signal.

17. The device according to claim 14, wherein said light emitting apparatus and the light receiver are arranged immediately adjacent to each other.

18. The device according to claim 14, wherein said light emitting apparatus comprises a first light source and a second light source.

19. The device according to claim 14, further comprising a microcontroller coupled at least to said light emitting apparatus and to said analysis unit and configured for time-synchronizing said light emitting apparatus and said analysis unit.

20. The device according to claim 14, wherein at least one of the following is true:
the first spectral distribution of the first light pulse lies in the near-infrared spectral range;
the second spectral distribution of the second light pulse lies in a visible spectral range.

21. The device according to claim 20, wherein the second light pulse lies in the blue spectral range and/or the violet spectral range.

22. The device according to claim 14, wherein one or both of the first and second light pulses have a temporal length in a range between 1 μs and 200 μs.

23. The device according to claim 14, wherein one or both of the first and second light pulses have a temporal length in the range between 10 μs and 150 μs.

24. The device according to claim 14, wherein one or both of the first and second light pulses have a temporal length in the range between 50 μs and 120 μs.

25. The device according to claim 14, further comprising an insect repelling device coupled to said analysis unit and activatable in an event of extraneous time-variable fluctuations in one or both of the first output signal and the second output signal.

26. A method for detecting smoke by optical scattered light measurements, the method which comprises:
providing the device according to claim 14;
emitting a temporal sequence of light pulses by way of the light emitting apparatus, with a first light pulse having a first spectral distribution and a second light pulse having a second spectral distribution different from the first spectral distribution;
receiving first scattered light from the first light pulse and second scattered light from the second light pulse by way of the light receiver;
providing a first output signal indicative of the first scattered light, and a second output signal indicative of the second scattered light; and
comparing the first output signal with the second output signal with the analysis unit.

27. A method for detecting smoke on the basis of optical scattered light measurements, the method which comprises:
emitting a temporal sequence of light pulses by way of a light emitting apparatus, with a first light pulse having a first spectral distribution and a second light pulse having a second spectral distribution different from the first spectral distribution;
receiving first scattered light from the first light pulse and second scattered light from the second light pulse by way of a light receiver;
providing a first output signal indicative of the first scattered light, and a second output signal indicative of the second scattered light; and
comparing the first output signal with the second output signal with an analysis unit.

28. The method according to claim 27, which further comprises aligning the intensities of the first and second light pulses so that when the first and second light pulses are scattered from a reference scattering object the first output signal and the second output signal are equal in size.

29. The method according to claim 27, wherein the step of comparing the first output signal with the second output signal comprises calculating a difference between the first output signal and the second output signal.

30. The method according to claim 29, which further comprises compensating a slowly varying difference signal toward a zero signal.
